(19) United States
(12) Patent Application Publication
(10) Pub. No.: US 2003/0079158 A1
(43) Pub. Date: Apr. 24, 2003

(54) Secured digital systems and a method and software for operating the same

(76) Inventors: James Brian Tower, Tracy, CA (US); Sean David Chumura, Monaca, PA (US)

Correspondence Address: Richard V. Westerhoff, Eckert Seamans Cherin & Mellott, LLC, 44th Floor, 600 Grant St., Pittsburgh, PA, 15219, US

(21) Appl. No.: 09/999,786

(22) Filed: Oct. 23, 2001

(51) Int. Cl. G06F 11/00

(52) U.S. Cl. 714/23

(57) ABSTRACT

Secured data systems only process file units which have not been compromised, such as by a malicious attack or corrupted data. The file units remain encrypted except during processing with successive generations of each encrypted file unit stored in a secured memory, which cannot be overwritten but only copied. Compromised file units are reconstructed or replaced by the last pure generation stored in secured memory. System operation is automatically restored following a fault, although the likelihood of faults is reduced by frequent optimization of system operation. Digital systems only accept file units from other secure digital systems having an approved digital identifier, which is embedded in each file unit.

### BACKGROUND OF THE INVENTION

1. Field of the Invention

This invention relates to a method, apparatus and software for manipulating data in digital systems. In particular, the invention provides digital systems with a secure method of operation that prevents and removes threats of compromise to data, instructions or digital system operation. The invention further allows the digital system to recover from faults or comprises that occur during the operation of the digital system, in particular during the processing of data.

2. Background Information

A digital system consists of a combination of components that work together to perform data manipulation. This combination includes hardware, software, firmware, and peripheral devices, which are necessary for the digital system to function.

Currently, digital systems are prone to the following problems:

Security Breakdowns

Improper Maintenance

System Faults

Unreliable Backup Systems

Improper Installation of New Software

Unreliable Methods of Virus Detection & Prevention

Unreliable Data Management Techniques

Security Breakdowns

Security breakdowns can occur when intruders break in and create havoc to digital systems and networks. Such break-ins can go unnoticed because it is not easy to track them, let alone track the havoc they leave behind given the current methods of digital system security. Furthermore trying to recover from the havoc can be insurmountable.

Digital systems currently uses addresses to identify themselves. To change the identity, a simple alteration to the address or communication interface card is performed and a new identity is formed. Today, experts are not always able to trace the source of malicious intent due to lack of adequate security and the methods by which digital systems handle data.

Improper Maintenance

Digital systems require constant maintenance to allow them to function at optimum levels of performance. Often maintenance routines are performed infrequently or not at all until a system failure occurs.

Typically when the maintenance routines are performed, important data and software are often deleted by mistake causing additional system failures due to the many complex sets of instructions that are contained within a digital system. The deletions occur typically during attempts to acquire additional memory storage capacity. These sets of instructions or data are often critical to system operation and their removal goes unnoticed until called upon causing system faults.

Maintenance today can be scheduled to occur at predetermined intervals, and typically involves complex routines manually customized to the preference of the customizer. There are no current methods for automatically performing maintenance routines before and after processing sets of instructions. It is more a matter of scheduling events to gain a window of opportunity than a systematic method for providing exactness to the occurrence of maintenance. Nor is there a system that checks the digital system to determine which maintenance procedures need to be performed to keep the system operating at its most optimal level of operation.

System Faults

A system fault occurs when the operating system or an application program stops processing. Not all system faults result in system failure. Some faults require the user to restart the digital system manually when a missing instruction is not found. Other faults prevent the digital system from starting, requiring maintenance to restore operation. Common faults are those related to conditions that constant routine maintenance would prevent. These conditions include fragmented memory, resources such as ports, interrupts, and memory not yet released following completion of a routine. When a digital system requires a resource and it is unavailable, a system fault occurs requiring intervention to restart the routine or the entire operation of the digital system itself.

When a critical system fault or failure occurs, the digital system often requires a complete reinitializing and reloading of the entire system to regain the operational functionality it had prior to the fault or failure. Currently, an expert is often needed to perform the recovery, which is very time consuming and not always initially successful.

Backup System Unreliability

Backup systems do not instantly backup data and software as changes are made. They are scheduled to run periodically, such as once per day or week, or more frequently, depending on how they are configured. Typically only changes to data are backed up. Tape media and archive systems are slow and take considerable time to backup the large amounts of data that exists on a network or individual system.

When system failures occur, system operation must be restored prior to the restoration of data. Untimely failure results in the loss of time and money, the extent of which is heavily dependent upon the level of expertise of attending personnel and the complexity of the procedures required during the restoration process. There is no current means for the automatic recovery of data through forensic examination and restoration. Only experts in forensic recovery operations can attempt recovery. The process is not automated and is not always successful.

Given the current methods of recovery, backups are typically used as a means of recovery; however, the latest version of a file may not be available on the backup, and therefore, an alternate must be used.

Improper Installation of New Software

Software management is an arduous task that requires excessive time and resources. The successful result depends upon the skill of the experts that maintain the systems. The more systems and software that reside on each system, the higher the total cost of ownership is in maintaining the system. With today's systems, when software is added, it can change, replace or remove files. This includes system and personal settings that may be changed in adding a new device or software program or program update.

Unreliable Methods of Virus Detection & Prevention

There are many programs that will check a digital system for known viruses, scan incoming files, and provide warning before any infected files are let in. An important fact about these programs is that they are only as good as their database of known viruses. Since new and different viruses are being introduced all the time, anti-virus databases need to be updated often.

Unreliable Data Management Techniques

When data or sets of instructions are created today, they each receive a file name. Within a single directory, filenames must be unique although files in different directories may have the same name. Some operating systems allow a file to have more than one name, called an alias.

File naming causes great difficulty in managing data as a file is only identified by its name or the time and date when it was saved in memory. The process of tracking the evolution of a file is not exacting as each user selects standards to name files that may not be the same that an organization or other user would assign to the same file.

When changes are made to a file, the file is either overwritten or given a new name. Overwriting a file changes the original file. There are a few work a rounds for this problem, namely keeping an archive or backup of the original file. Tracking the history of a particular piece of data would involve the arduous process of finding each piece of data and identifying the evolution based on name, date, etc. Using the same name for data over time would add much complexity to the process.

Data on its own has no meaning; it only has meaning when interpreted by some kind of digital system that can perform data processing. The end user must make the determination as to which generation of a file to use. Based on the complexity of managing data using the current methods of data management, often additional manipulating of the data to reach the desired results must be performed manually by the user.

Encryption Techniques

Typically, data is encrypted for transmission to another digital system and decrypted once received. Even when data is encrypted there is no means of tracking the sensitive data from the inception of the data and to all those who have intercepted or reviewed the sensitive data, whether authorized or not to do so. Often, when data is to be transmitted to another digital system, a check sum, which is a function of the individual bit values, is included to verify the integrity of the received data.

As can be appreciated, there is a need for improvement in digital systems, their methods of operation, and software for their operation.

### SUMMARY OF THE INVENTION

This need and others are satisfied by the invention which is directed to a method, apparatus and software for secured operation of digital systems. The invention embraces the overall architecture of such secure systems as well as the storage and manipulation or processing of file units in such systems. As used throughout, the term “file unit” means any distinct piece of digital information that is manipulated, stored, transmitted or contained within a digital system. A file unit can contain data, program instructions, or portions and combinations of data and program instructions.

In accordance with the invention, file units are stored in a memory vault also referred to as a secured memory and only copies are made for processing. The processed file unit is not written over the original file unit, but instead is stored separately in secured memory. The successive generations or versions of a file unit are linked in a memory map. Thus, if a file unit becomes corrupted, damaged or lost, the next most recent generation is available in secured memory for recovery.

As another aspect of the invention, instructions are monitored as they are performed. If a fault occurs, the system is calibrated and the instructions are automatically reperformed in the order in which they were originally performed up to the fault. The calibration performs routine maintenance such as clearing out memory and freeing up resources such as ports and interrupts.

Also in accordance with the invention, the integrity of file units is maintained through a purification process. Purification begins when a file unit is originated and it may also be necessary as a result of a violation of the file unit's purity incurred while participating in processing, storage, or retrieval events. Data is tagged with identifying elements that are stored in a memory map to aid in the identification and state of each file unit. These elements include a unique file unit identifier, a digital system ID and a check code. The digital system ID is a unique identifier incorporated into each digital system such as by firmware. Linked digital systems can be configured to only accept, process and transmit file units associated with authorized digital systems.

Purity is initially checked by comparing the tag elements of a file unit with those stored in the memory map. When an impure file unit is found, a bit-by-bit analysis, which looks for conditions such as hidden or malicious code within the data, more than one header, more than one end of file marker, a mismatch between the header and end of file marker, and missing, unreadable or additional bits that do not match the check code value, is performed. Where there are missing, unreadable or additional bits, a recovery can be performed to reconstruct the corrupted file units by substituting bits for missing or unreadable bits. This can be accomplished, for instance, by a bit-by-bit comparison with the original file unit stored in secured memory. Alternatively, the bits of a corrupted file unit can be compared with a character code set to determine a best match from a plurality of potential best character code matches. For text based file units, a spell-check, dictionary check and grammar check can be used to assist in determining the best character code match, or when the file units are expressed in hexadecimal code, a substitute hexadecimal code can be used which produces the check code of the file unit.

In accordance with an additional aspect of the invention, the file units are encrypted and remain encrypted except during processing. Not only is the data element of a file unit encrypted but also the tag elements using a separate encryption key. The tag unit requires decryption before the data element can be decrypted as the tag contains the key for the data element encryption.

Yet another aspect of the invention relates to changes in program instructions. The changes are applied to copies of the original instructions, which remain in secured memory, to produce proposed instructions. The proposed instructions are then preprocessed and the results analyzed to determine if any faults or compromises are produced. The new or changed instructions are then selected from the proposed instructions and linked to the original instructions which remain unchanged in secured memory.

More particularly, the invention is directed to a digital system, a method of operating a digital system and software for operating a digital system which includes withdrawing file units from a memory area, processing the file units to generate processed files units, establishing purity of the processed file units, and placing the pure processed file units in the memory area.

The invention is further particularly directed to a digital system, a method of operating a digital system and software for operating a digital system which includes repeated withdrawal of file units from a memory area, processing each file unit withdrawn from the memory area to generate a new generation of the file unit, associating each generation of each file unit with the file unit from which it was generated, and maintaining in memory at least the two most recent generations of each file unit.

The invention further includes a digital system, a method of operating a digital system and software for operating a digital system which includes performing each instruction in a set of instructions in order, placing in memory the results of the performance of each instruction, detecting faults in the performance of the instructions, and upon detection of a fault, automatically restarting the performance of the set of instructions in the predetermined order.

In addition, the invention includes a digital system, a method of operating a digital system and software for operating a digital system which includes detecting corrupted file units and replacing the corrupted file units with uncorrupted file units. This includes reconstructing corrupted file units, and if that is not possible, or as an alternative, substituting an earlier uncorrupted version of the corrupted file unit from secured memory.

Another aspect of the invention is a digital system, a method of operating a digital system, and software for operating a digital system which includes providing each of a plurality of associated digital systems with a unique digital identifier unique to that digital system and operating the associated digital systems to each insert in all file units processed the unique digital identifier assigned to that digital system and to only process file units containing one of the assigned unique digital identifiers.

In addition, the invention encompasses a first digital system connected for communication with at least one other digital system, a method of operating the first digital system and software for operating the first digital system including operation of the digital system: to perform processing of file units, to at least partially encrypt each file unit after each performance of processing, and to only decrypt the at least partially encrypted file units to form decrypted file units for the performance of processing.

Furthermore, the invention includes a digital system, a method of operating a digital system, and software for operating a digital system which includes automatically operating a digital system to: purify file units containing program instructions to generate pure file units, store the pure file units in a secured memory, copy the pure file units to an open memory, execute a sequence of program instructions in the file units copied to open memory, detect faults during execution of the sequence of program instructions in the file units copied to open memory, restart the sequence of program instructions in file units copied to open memory, make a copy in open memory of the pure file units in secured memory when restart is not effected, and execute the sequence of program instructions in the file units newly copied to open memory.

Additionally, the invention includes a digital system, a method of operating a digital system, and software for operating a digital system which includes operating a digital system to: maintain a process map listing characteristics of sets of instructions in file units, process the sets of instructions in file units, and map to the process map effects on the characteristics to the sets of instructions resulting from processing.

### BRIEF DESCRIPTION OF THE DRAWINGS

A full understanding of the invention can be gained from the following description of the preferred embodiments when read in conjunction with the accompanying drawings in which:

FIG. 1 is a diagram illustrating elements of a digital system incorporating the invention.

FIG. 2 is a diagram functionally illustrating the architecture of memory in the digital system of FIG. 1.

FIG. 3 illustrates the structure of a file unit and the contents of the memory map which include elements of the file unit in accordance with the invention.

FIG. 3a illustrates a process map, which is used in accordance with certain aspects of the invention.

FIG. 4 is a functional diagram illustrating application of the digital ID aspect of the invention to multiple digital systems.

FIG. 5 illustrates the overall logic for operation of digital systems in accordance with the invention.

FIG. 6 illustrates the organization of the secured manipulation access point illustrated in FIG. 5.

FIG. 7 is a flow chart of the preprocessing security routine utilized at the secured manipulation access point.

FIG. 8 is a flow chart of the security authorization check routine called by the preprocessing security routine.

FIG. 9 is a flow chart of the purity check routine called by the preprocessing security routine.

FIG. 10 is a flow chart of the manipulation routine implemented at the secured manipulation access point.

FIG. 11 is a flow chart of the transaction processing routine called by the manipulation routine.

FIG. 12 is a flow chart of the post-processing security routine implemented at the secured manipulation access point.

FIG. 13 is the changing instructions routine which is implemented to change or add instructions.

FIG. 14 is a flow chart of a first embodiment of the restart-recovery routine referenced in the overall logic diagram.

FIG. 15 is a flow chart of another embodiment of the restart-recovery routine.

FIG. 16 is a flow chart of the comprehensive bit-by-bit analysis routine called by the purity check routine.

FIG. 17 is a flow chart of the condensed bit-by-bit analysis routine called by the restart-recovery routine.

FIG. 18 is a flow chart of the match routine called by the restart-recovery routine to reconstruct file units with corrupted or missing bits.

FIG. 19 is a flow chart of the calibrate routine referenced in the overall logic diagram.

### DESCRIPTION OF THE PREFERRED EMBODIMENTS

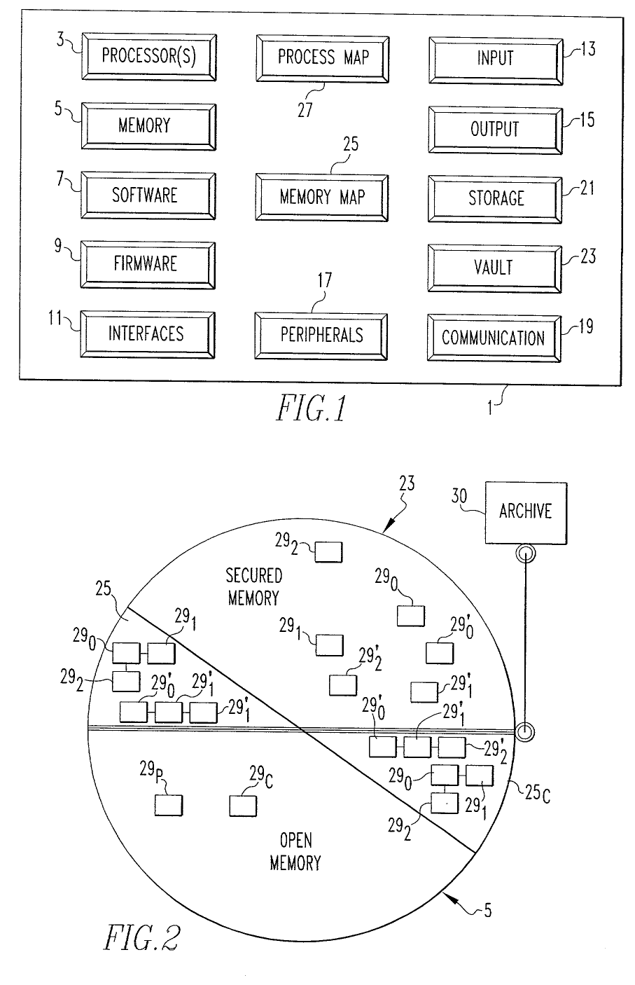

The invention is directed to the architecture, structure, and operation of digital systems in general, operating individually or in association with other digital systems. As illustrated in FIG. 1, such digital systems 1 include one or more processors 3, various types of memory 5, software 7 and/or firmware 9, and various types of interfaces 11 which can include inputs 13 and outputs 15. Such systems can also include various peripherals 17, and depending upon the application communications 19 and external storage 21. In addition, in accordance with preferred embodiments of the present invention, the digital systems 1 can also include a vault 23, which as will be seen is a secured memory, a memory map 25 for managing the memory 5 and vault 23, and a process map 27, which contains information about the instructions performed by the system.

Digital systems in accordance with the invention are organized to provide increased reliability and to be secure from unauthorized access, and particularly malicious attack. To further these purposes, they are provided with the ability to recover from faults and to reconstruct damaged file units.

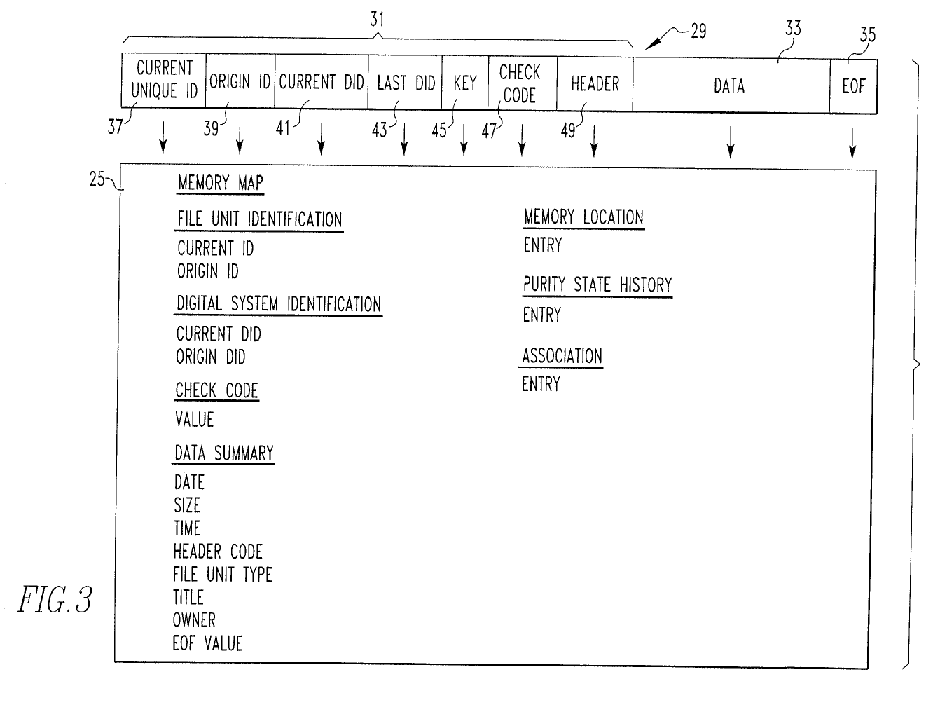

The secured memory or vault 23 is one unique aspect of the invention. As shown in FIG. 2, the secured memory 23 operates in conjunction with the memory 5, which in the manner used in the invention becomes open memory. File units 29 stored in the secured memory 23 are not overwritten so that they are always available in their original form. Whenever a file unit such as 29ₒ is needed for processing, it is cloned or copied 29_{c} into the memory 5. The secured memory 23 can be a portion of a common memory shared with the open memory 5, such as sectors of a hard drive. Alternatively, the secured memory 23 can be a memory device separate from the open memory 5. In addition, the open memory 5 can be any one or more of various types of memory devices such as a hard drive, ram, or a buffer associated with a processor, or any other type of memory. The cloned file unit 29_{c} copied from the secured memory 23 is then provided by the open memory 5 to the processor 3 for manipulation or processing. The resulting or processed file unit 29ₚ is placed in the open memory 5. As will be seen, the resulting or processed file unit is checked for purity, or purified if it is new, before being placed in the secured memory 23. As the original version of the file unit 29ₒ in secured memory 23 is not written over, this new version or generation of the file unit 29₁ is placed separately in secured memory 23, but is associated with its parent 29ₒ in a memory map 25 which is also stored in secured memory 23. A copy of the memory map 25_{c} is also maintained in the open memory 5, and as in the case of the file units, the linkages in the open memory map are checked for purity before being copied to the memory map in the secured memory 23. Each successive generation of a file unit is linked to the previous generation in the same manner.

Each generation of a file unit can be complete or can just contain changes from the previous generation. Thus, the generations of the file unit 29ₒ, are 29₁, 29₂, and so forth, and each successive generation is complete. In this instance, it can be acceptable to only retain the most recent or a few most recent generations of the file unit. Alternatively, each successive generation, 29′ₒ, 29′₁, 29′₂ and so forth of the file unit can contain only the changes from the previous generation. In this case, all of the generations are needed to determine the current state of the file. It could be advantageous to periodically, or under other conditions, create a new “parent” file unit incorporating all of the changes. If desired, the contents or older portions of the contents of secured memory 23 and the associated linkages in the memory map 25 can be periodically sent to an archive 30.

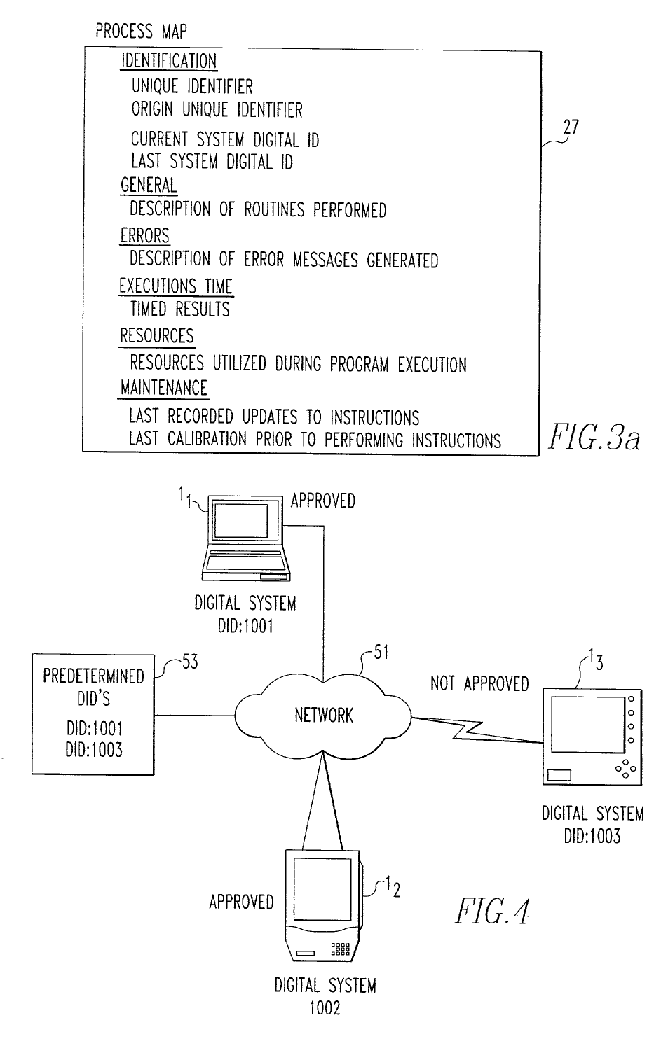

The construct of a file unit is illustrated in FIG. 3. Each file unit 29 includes a tag 31, a data element 33, and an end of file (EOF) marker 35. In accordance with the invention, each file unit 29 is tagged with a unique identifier 37, which is placed in the tag 31. The tag also includes an origin ID 39 which is the unique ID of the file unit from which this file unit was generated. In addition, as will be explained more fully, in multiple digital system environments, each of the digital systems 1 is given a unique digital identifier or DID. The tag 31 includes the DID 41 of the digital system 1 in which the current generation of the file unit 29 was generated. The tag also includes the DID 43 of the last of any other digital system from which the file unit came. As another aspect of the invention, each of the file units 29 can be encrypted and is only decrypted for processing. To further enhance the security of the system, the tag element 31 is encrypted with a first key, and the data element 33 is encrypted with a second key 45 which is incorporated in the tag 31 and must be decrypted as part of the tag using the first key.

The tag 31 of each file unit 29 also includes a check code 47 which is a function of the bit values of the data element 33 or the entire file unit including the tag. Any of the known check codes can be employed. Finally, the tag 31 can also include a header 49 such as is currently provided with a file unit. Such a header 49 typically includes such information as the date, the size of the file, the time it was created and can include a title and owner or other suitable information. As previously mentioned, the data element 33 can contain data, instructions, portions of data or instructions, or any combination of these. As is conventional, the EOF marker 35 marks the end of a file.

As indicated in FIG. 3, certain of the information contained in the file unit is stored in the memory maps 25 and 25_{c}. In addition, each memory map stores the location of the file unit in memory, a purity state history (such as pure or compromised) and the time of the classification, and an association of the generations of the file unit.

The process map 27, mentioned above as an element of digital systems in accordance with the invention, is illustrated in FIG. 3a. It is used to track and analyze the performance of sets of instructions (software routines) implemented by the digital system. Thus, it maintains a listing of certain characteristics of the sets of instructions and the effects processing has on those characteristics. For instance, the process map tracks any compromises resulting from preprocessing of proposed changes to program instructions, which is discussed below, so that those changes are not implemented. It is also used in tracking run times of sets of instructions so that attention can be directed to the need for a calibration to correct deteriorating system performance. As shown in FIG. 3a, the process map includes, in addition to identification of file units containing the sets of instructions, a description of the routines performed, a description of error messages such as faults generated, execution time for the set of instructions, the resources utilized during program execution, such as for instance, peripherals, and a maintenance history which includes updates to the instructions and when the last calibration was performed.

The digital identifier DID is used to enhance the security of multiple digital systems 1 which are interconnected such as through a local area net, an intranet, the global network, or otherwise. Such connections can be implemented by hard wire, fiber optic, wireless or any combination of these or other medium. The DID uniquely identifies each of the plurality of digital systems which are interconnected. The DID is incorporated into each of the processors in each digital system, preferably through the use of firmware. Thus, not only each of the one or more processors in the system's central processing unit, but processors, for instance, in a printer, a communication device and other peripherals and interface devices will also incorporate the DID.

A common unique DID is used for all of the processors in a given digital system. As shown in FIG. 4, the digital system 11-13 each have their own unique DID such as 1001-1003, respectively. As mentioned above, each file unit incorporates in its tag 31 the DID 43 in which it was last processed. Associated digital systems in a network 51 will only accept and process file units from a digital system having a predetermined DID on an approved list 53. Thus, in the very simplified example of FIG. 4, digital systems 11 and 12 are associated digital systems and will accept and process file units from each other as their DIDs are on the approved list 53. On the other hand, neither of these digital systems will accept or process file units from the digital system 13 which has a DID which is not on the approved list. In addition, file units from a digital system that does not have a DID at all would also not be accepted or processed. As was discussed, the DIDs are embedded in the tag 31 of each file unit which can be encrypted for enhanced security.

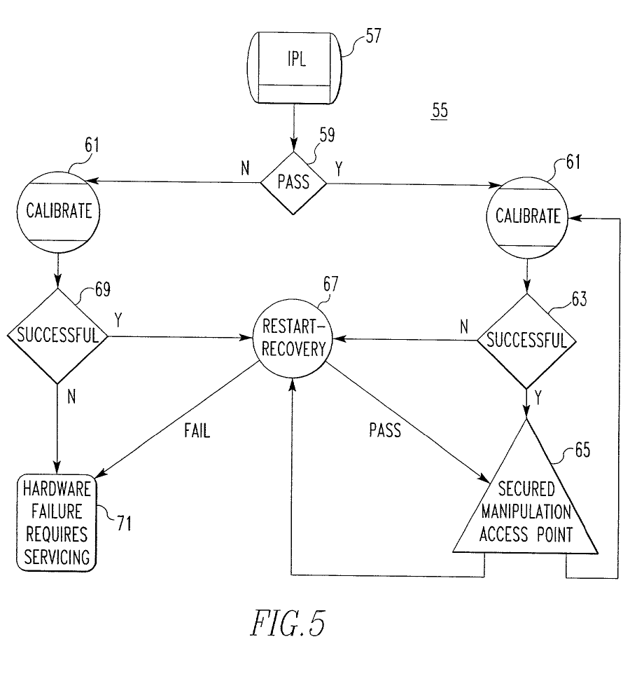

Other aspects of the invention will become evident as the operation of the digital systems is now described. FIG. 5 illustrates an overall logic diagram 55 of a digital system 1. It is a self-determining and self-acting logic which analyzes system activity or events and makes decisions that maintain or restore system integrity and/or data. Problematic events and other calamities that compromise or have the potential to compromise the system are managed through self-discovery, and if necessary, recovery, to prevent instability or contamination of the system or data.

As shown in FIG. 5, the overall system logic 55 begins with an initial program load, IPL, 57 that performs comprehensive diagnostics in the form a power on self test, as is known in the art. If the tests are successively passed at 59, a calibration is performed at 61. This calibration, which is described more fully in connection with FIG. 19, optimizes the system for performance. If the calibration is successful at 63, the logic proceeds to 65 which is the secured manipulation access point. Implementation of the various application programs is carried out at this point. As long as the digital system is operating normally with no faults or compromises, the system continues to operate in this mode. However, even with normal operation, a calibration is repeated either periodically, after completion of predetermined routines or a predetermined number of routines, or even at times during a particularly long routine. This recalibration assures continued optimal operation of the digital system.

If a fault should occur during secured manipulation at 65, a restart-recovery program 67 is called. As will be described, the restart-recovery program 67 automatically restarts the operating system, and if successful, passes control back to the secured manipulation access point 65. Should a calibration at 61 be unsuccessful at 63, the restart-recovery program 67 is also called to place the system in condition for continued operation at 65.

If the digital system does not successfully pass the power on self-tests at 57, a calibration is also performed, and if successful at 69, the restart-recovery program is called at 67. If the calibration is not successful at 69 or the restart-recovery program 67 is not able to correct the problem detected, a hardware failure which requires servicing is signaled at 71. Under these circumstances, hardware service will have to be performed before the system can be returned to operation.

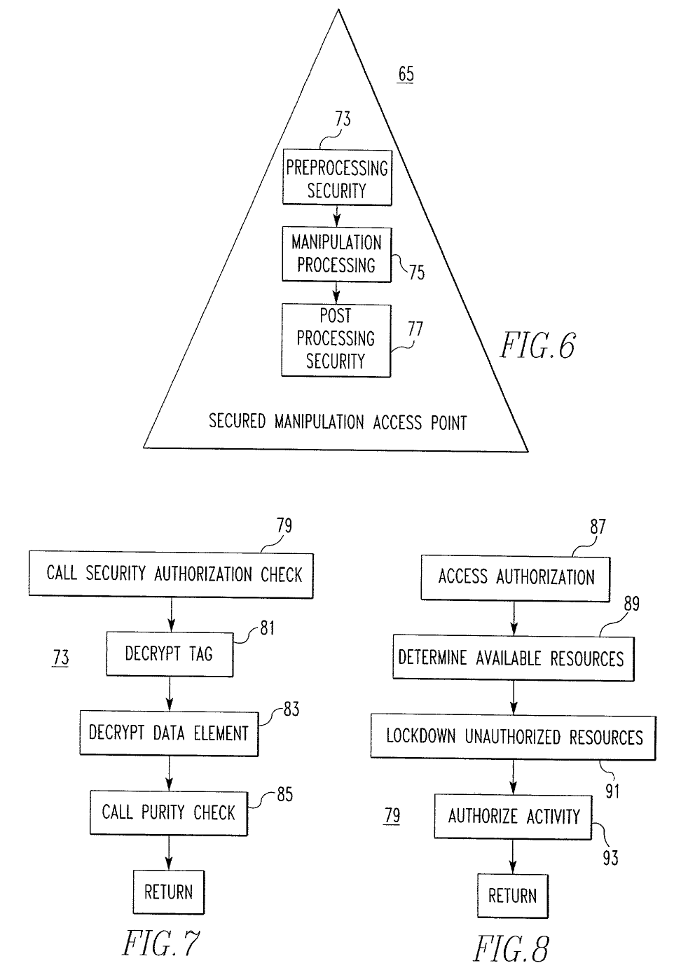

The programs implemented at the secured manipulation access point 65 are illustrated in FIG. 6. A preprocessing security routine 73 is called before the manipulation processing routine 75 that implements processing of the file units. At the conclusion of manipulation processing, a post-processing security routine 77 is implemented. This sequence of routines is called for each file unit being processed by the digital system. In this manner, the file units remain encrypted except for processing.

The pre-processing security routine 73 is set forth in FIG. 7. For file units that have been received from outside the digital system a security authorization check is called at 79. The file unit is then decrypted by first decrypting the tag at 81 using the first encryption key, and then using the second encryption key imbedded in the tag to decrypt the data element at 83. For file units that have not been copied from the digital system's secured memory, a purity check 85 is called.

The security authorization check 79 is illustrated in FIG. 8. As mentioned, this routine is called for file units which have been received from outside the digital system. First, access authorization is checked at 87. This routine acquires authorization information such as the user name and password to verify that the user providing the information has authorization. Furthermore, it prevents the use of anonymous user logins, even if the operating system software allows use of anonymous logins. This prevents accessing or obtaining authorization information by an outside requester. It also prevents the use of NetUserGetlnfo and other such authorization help utilities. Next, at 89 a determination is made of the permissions and accessibilities of shared resources authorized for this user. The shared resources can include listening TCP ports and devices that authenticate. The addresses of devices in the listen ports are scanned to determine if they are available for the level of authorization possessed by the requester. Unauthorized resources are then locked down at 91 and other activities are authorized at 93. The lockdown not only locks down shared resources not authorized by the authorization account but also monitors the unauthorized resources for access attempts, which are logged and reported to administrative personnel. Locking prevents data deletion or data creation, access or examination of data without unlocking, and performance of the data scan. Returning to the preprocessing security of FIG. 7, the tag 31 of the file unit is decrypted at 81 using a first encryption key. As mentioned, the tag includes a second encryption key which is used at 83 to decrypt the data element of the file unit. If the file unit was not copied from the secured memory of the digital system, the purity check routine 85 is called.

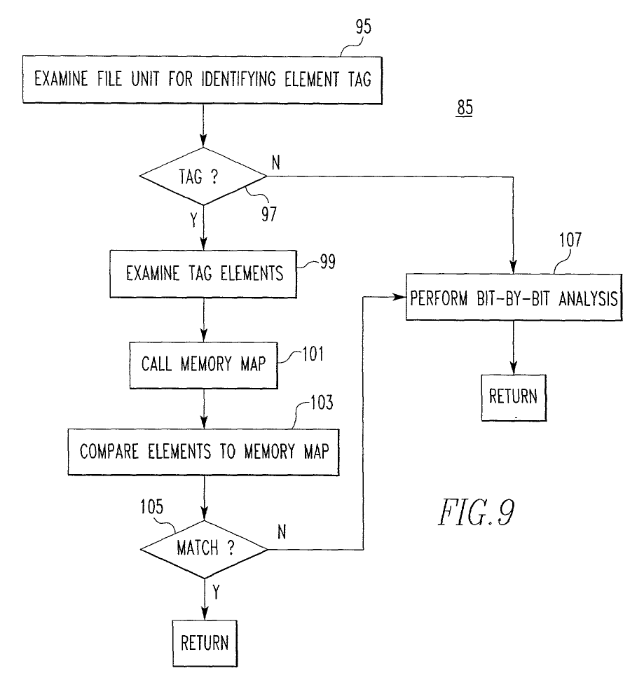

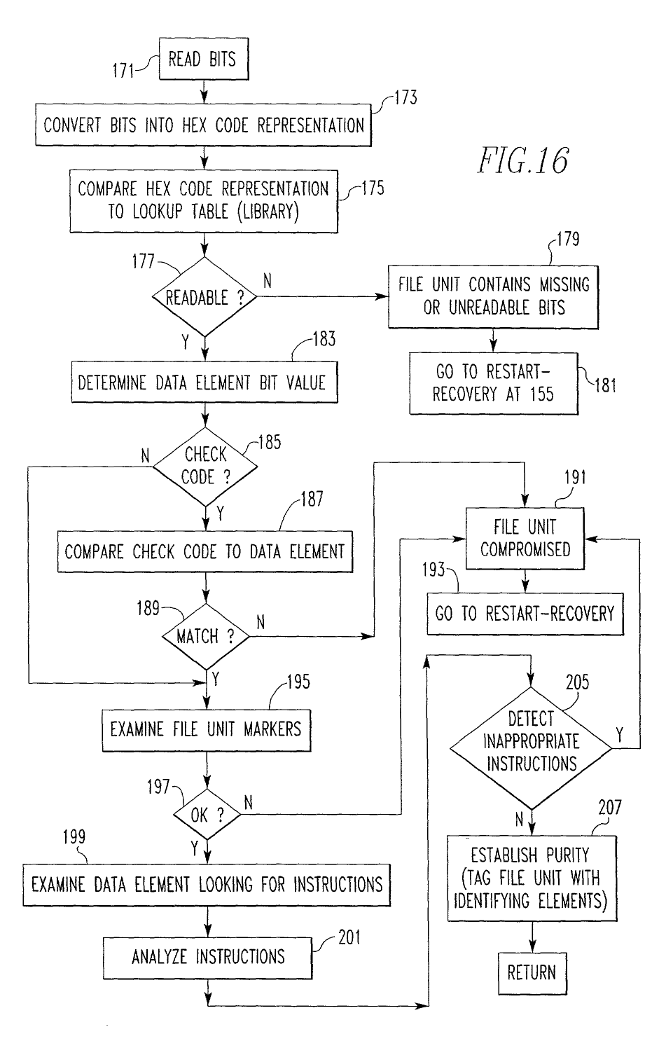

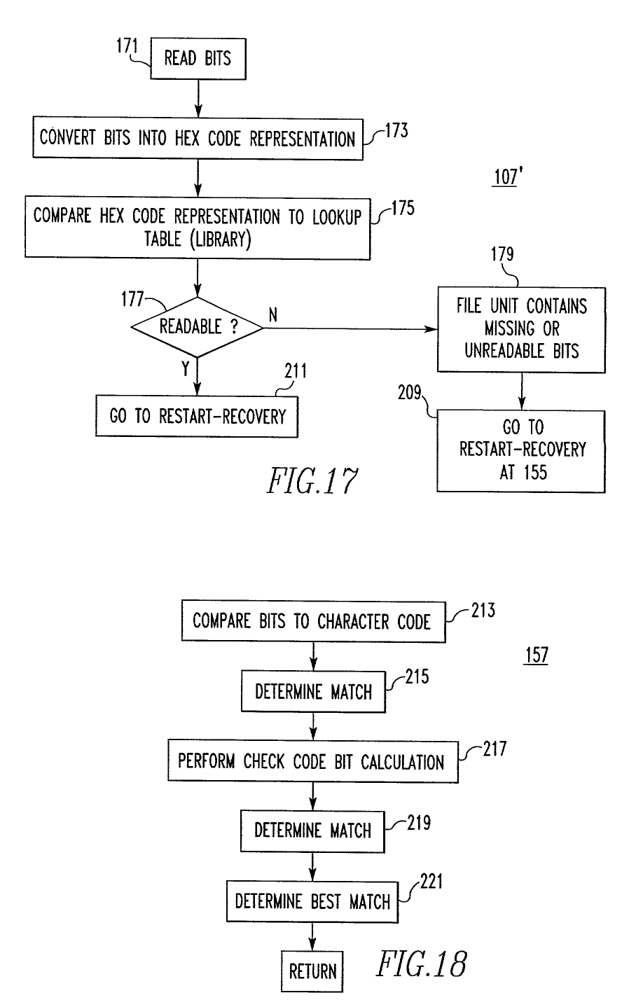

The purity check routine 85 is illustrated in FIG. 9. The file unit is checked for the tag at 95. If the tag is found at 97, the tag elements are compared with the tag elements for that file unit (identified by its unique file ID) in the memory map at 99, 101 and 103. If the tag elements match those in the memory map at 105, then the file unit is considered to be pure. However, if the file unit does not have an identifying tag element or the tag element does not match that stored in the memory map, a bit-by-bit analysis is performed at 107. This bit-by-bit analysis is described in connection with FIGS. 16 and 17.

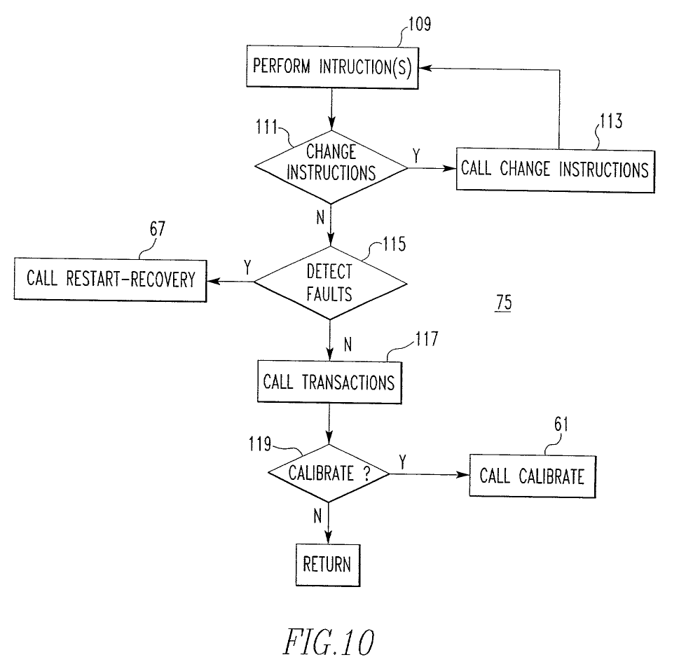

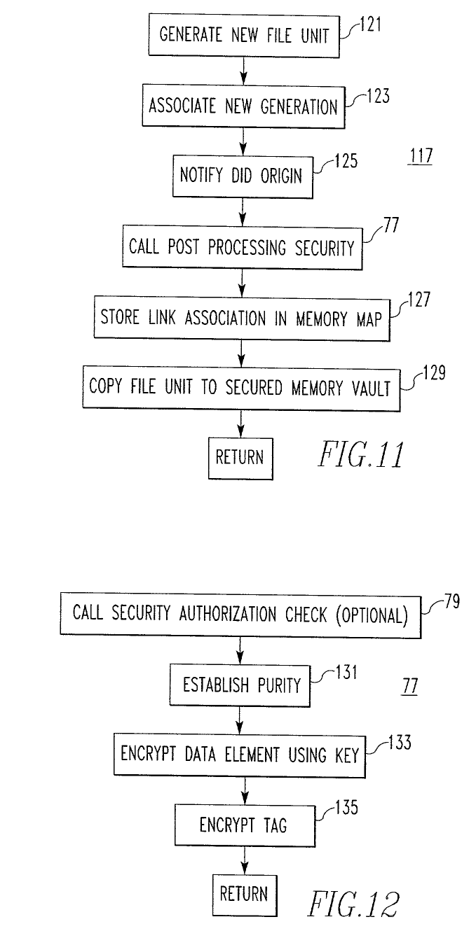

A file unit that has been determined to be pure by preprocessing security, or is assumed to be pure since it was copied from the secured memory, is passed to the manipulation processing routine 75 which is illustrated in FIG. 10. This manipulation routine 75 implements processing which can include creation or changing of data, movement of data and changing of instructions. The instruction is performed at 109. If it is found at 111 that the instruction is a program change, which includes the addition of a new instruction as well as a change to an existing instruction, the change instruction routine is called at 113. If performance of the instruction produces a fault which is detected at 115, the restart-recovery routine 67 is called. If no fault is generated, then the transaction routine is called at 117. As was mentioned, calibration 61 is initiated, as determined at 119, at times during processing such as periodically, or after completion of certain routines or a number of routines or during a particularly long routine.

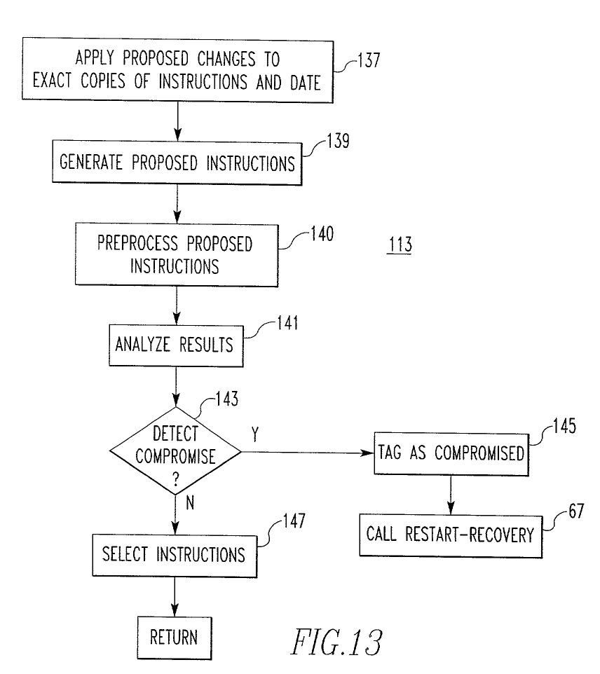

The transaction processing routine 117 is illustrated in FIG. 11. As the original of each file unit remains, unchanged in secured memory, processing results in the creation of a new file unit at 121. This entails generating a new tag 31 which contains all the tag elements described above, including the unique identifier for the file unit. This new file unit is then associated as a new generation at 123 of the file unit from which it was derived. If the file unit came from another digital system, the originating digital system is notified through its DID at 125. This allows the originating digital system to determine whether the file unit it sent was processed by an approved digital system or ended up in an unapproved system. Post-processing security 77 is then called, which as will be seen, includes encrypting the file unit. The link association of the new file unit with its parent is then stored in the memory map at 127, and new encrypted file unit is copied to the secured memory vault at 129. As previously emphasized, this new memory unit is stored separately from and is not written over the originating file unit in the secured memory.

The post-processing security routine 77 called by the transaction processing routine is illustrated in FIG. 12. Under certain conditions, such as when a file unit is sent to another digital system, the security authorization check 79, shown in FIG. 8, is called. Purity is then established at 131 by tagging the file unit with the identifying elements discussed above. The data element of the file unit is then encrypted at 133 using the second key which is one of the tag elements. Finally, the tag itself is encrypted using the separate, first key at 135.

The change instructions routine 113, which is called when it is determined during manipulation processing that the file unit contains an instruction calling for a change of an existing instruction or the addition of an instruction, is shown in FIG. 13. The proposed changes are applied to exact copies of instructions and data withdrawn from the secured memory as indicated at 137. This generates proposed instructions at 139, which are preprocessed at 140. The results of the preprocessing are analyzed at 141. If a proposed instruction produces a compromise at 143, the file unit is tagged as compromised in the process map at 145 and the restart-recovery routine 67 is called. If no compromise is detected, the proposed instructions are selected as new or modified instructions at 147. If a compromise is detected, only those instructions which do not pose a threat (are not compromised) are selected.

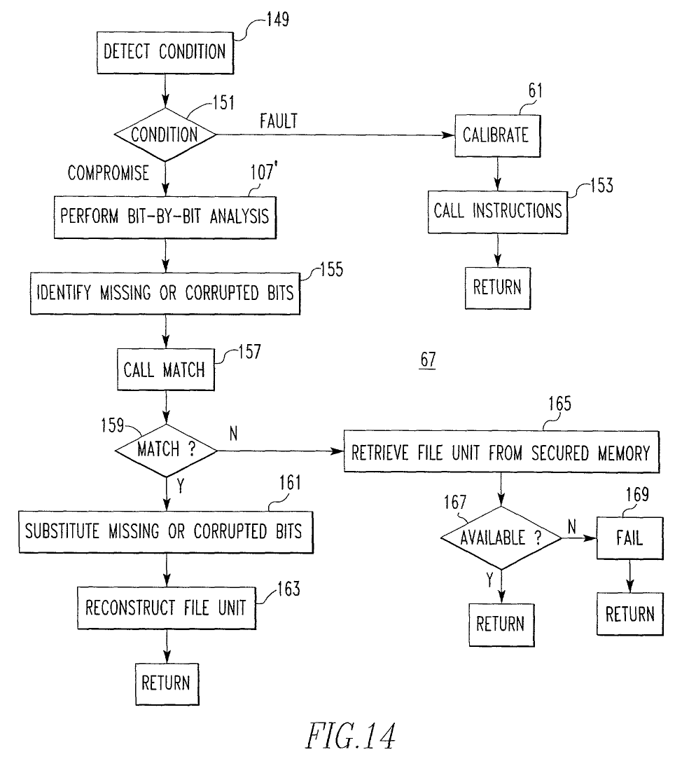

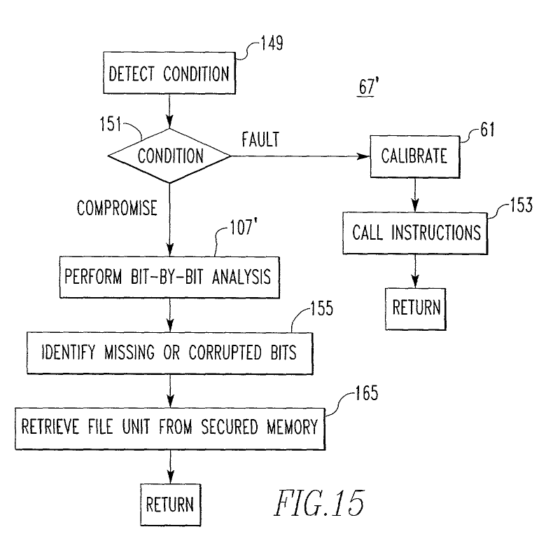

A first embodiment of the restart-recovery routine 67 is illustrated in FIG. 14. The condition that called the restart-recovery routine is detected at 149. If it is a fault, as determined at 151, the calibration routine 61 is called to return the system to its optimized state and the predetermined set of instructions is reinitiated at 153. Control is then passed back to the secured manipulation access point 65 (see FIG. 5) which restarts the system.

If it is determined at 151 in FIG. 14 that there is a compromise, such as might be caused by a virus, corrupt data or contamination, a recovery is performed. This portion of the routine restores stability and resolves compromise. When needed, recovery occurs through self-determinations based on the event which resulted in the compromise. This procedure, if successful, results in the least disruption to the system as processing up to the point of compromise is preserved. If this cannot be accomplished a seamless recovery returns the state of operation back to the last known time-stamped “load” stored within the vault or secured memory. If the system cannot be recovered due to hardware failure, a technician is notified or the problem is reported to the proper support resource. In an alternative form of recovery, the system reverts to the last state stored within the secured memory or vault directly, rather than attempting to reconstruct the compromised file unit.

Returning to FIG. 14, the recovery begins with a bit-by-bit analysis 107 of the data element of the compromised file unit. Any missing or corrupted, such as unreadable, bits are identified at 155 for logging purposes and the match routine is called at 157. If a match is established, as determined at 159, bits are substituted for the missing or corrupted bits at 161 and the file unit is reconstructed at 163. This includes re-establishing the check count in view of the changes in bit values.

If no match can be established at 159, then the latest generation of the file unit stored in secured memory is retrieved at 165. However, if a prior generation cannot be established at 167, there is most likely a hardware failure which is indicated at 169 and the system transfers to 71 in FIG. 5.

FIG. 15 illustrates an alternative restart-recovery routine 67′. This alternative routine differs from the restart-recovery routine of FIG. 14 in that instead of trying to reconstruct the damaged or compromised file, the system immediately retrieves the most recent uncompromised generation of the file unit stored in secured memory to re-establish stability.

As indicated, one of the functions of the invention is to assure the purity of the file units being stored, processed and manipulated by a digital system. Attacks on the purity of file units could be unintentional, as where data becomes corrupted, or it could be intentional and even malicious, as in the case of a virus or other assaults on the system. The invention not only detects that file units have become compromised, but in many cases, can determine the nature of the compromise, which can be used then by the recovery routine just discussed in reconstructing compromised data under certain circumstances. This task of determining the nature of the compromise is accomplished by the bit-by-bit analysis. The purity check, illustrated in FIG. 9, calls the bit-by-bit analysis if no tag is found in a file unit or if the elements of the tag unit do not match those stored in the memory map for that file unit.

The bit-by-bit analysis routine 107 called by the purity routine is illustrated in FIG. 16. The bits of the file unit are read at 171 and converted into hex code representation at 173 for comparison with a set of hex code representations in a look up table at 175. This reveals whether there are any missing or unreadable bits. If it is not possible to match the hex code representation with the hex code representation in the look-up table as determined at 177, then the tag contains missing or unreadable bits 179 and a transfer is made at 181 to the restart-recovery routine of FIG. 14 at 155. If the data is readable at 177, then the data element bit value is calculated at 183. If the file unit has a check code as determined at 185, the check code is compared with the just calculated check code of the data element at 187. If they do not match as determined at 189, then the file unit is labeled as compromised at 191 and the program transfers at 193 to the restart-recovery routine of FIG. 14 at 165.

When the calculated check code agrees with the check code attached to the file unit at 185, or where there was no check code as in the case of a new piece of data coming into the system, the file unit markers are examined at 195. The markers include the tag (incorporating the header) and the end of file marker (EOF). There should be only one header, one EOF marker and one data element. Also, the header and the EOF marker each indicate the type of file unit, and hence should match. For instance, if the header indicates that this is a jpeg file, so must the EOF marker. This analysis is useful in detecting viruses. For instance, viruses can add material to a file unit so that there are two headers or two EOF markers or, they can result in a difference between the files construct indicated by the header and that indicated by the EOF marker. If the header and the EOF marker do not agree as to file construct, or if there is more than one EOF marker or header code, then the markers are not okay at 197, the file unit is tagged as compromised at 191 and the program transfers to the restart-recovery routine at 193.

If the file unit markers are okay at 197, then the data element of the file unit is examined at 199 for instructions. These instructions are analyzed at 201 to determine if they contain intervention code requests. Instructions contain intervention codes to obtain input or values from other instructions or directly from the user to carry out the instructions. However, inappropriate instructions or malicious code, such as a virus, would contain the data which is referred to as being “scripted”. Thus, if an intervention code is scripted, meaning that it contains data or code to replace that which should be obtained from an outside source, the instruction is inappropriate. This again can be the result of an attack on the system such as by a virus.

When an instruction is detected as being inappropriate at 205, the file unit is again tagged as compromised at 191 and the program transfers to the restart-recovery routine at 193. On the other hand, if no inappropriate instruction is detected, and as will be recalled, the file unit also has readable bits and validated markers, purity is established at 207 by entering the appropriate tagged elements into the file unit as discussed above. This would occur for instance where a new file unit is being generated or was received from outside the digital system and has now been deemed as pure for use by the system.

A condensed bit-by-bit analysis 107′, called by the restart-recovery routines illustrated in FIGS. 14 and 15, is illustrated in FIG. 17. As in the analysis of FIG. 16, a determination is made whether the bits of the data element are readable. If they are not, then the file unit contains missing or unreadable bits at 179 and the program goes at 209 to the restart-recovery routine at 155. On the other hand, if the data element is readable at 177, it has still been identified as being compromised, and the program goes at 211 to the restart-recovery routine at 165 for retrieval of the last pure generation of the file unit.

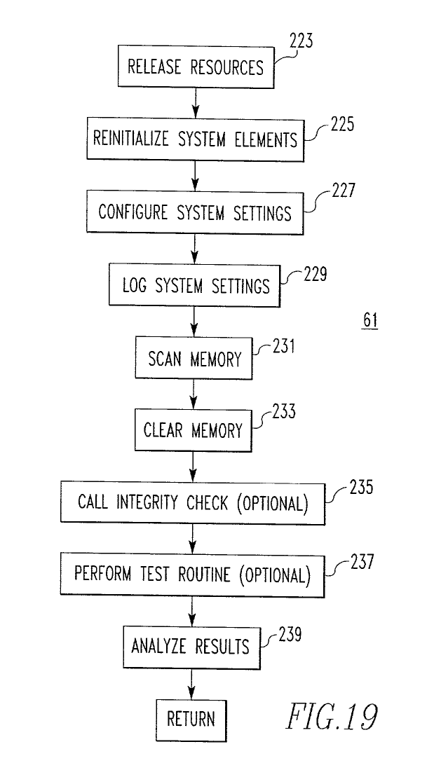

Returning to the restart-recovery routine of FIG. 14, when the bit-by-bit analysis 107′ has found that there are missing or corrupted bits and returns control to the restart-recovery routine, the missing or corrupted bits are identified at 155 and the match routine 157 is called. The match routine 157 is illustrated in FIG. 18. This routine compares the data element bits to a character code set at 213 to determine the potential best character code matches. It further includes then running at least one of a spell check, a dictionary check and a grammar check on the potential best character code matches to determine the best character code match at 215. Next, a check code bit calculation is performed at 217 for the data element using the best character code match which is then compared with the check code in the file unit to determine if there is a match at 219. If they match, then the best character code match is selected as a match at 221. If the check code in the file unit does not match the calculated check code, there is an alternative if there is only one missing or corrupted bit. The file unit check code can be reversed to provide correction of the missing or corrupted bit. The match routine 157 then returns control to the restart-recovery routine, which as noted there, makes the bit substitutions if there is a match.

As was previously discussed in connection with the overall logic illustrated in FIG. 5, a calibration is performed on start-up, before a restart when there has been a fault, and also at various times or points in processing to maintain the optimal performance of the digital system. A flow chart of the calibrate routine 61 is illustrated in FIG. 19. First, resources are released at 223. This includes clearing interrupts, both physical (hardware) and logical (software) interrupts, as well as physical ports and logical ports. Thus, for instance, a printer, which was tasked for a previous job but is not now needed is released. As an example of clearance of a logical interrupt, a scheduled task which was stopped because a priority task was in need of a resource is restarted after the priority task completes.

After the release of resources, the system elements are reinitialized at 225 of the calibration routine. This involves restarting system elements, including components and peripheral devices that are necessary to make the digital system function. Calibration also involves returning system settings, operational preferences and configuration parameters to select the predetermined settings such as for optimal performance at 227 and then loggings these system settings, operational preferences and configuration parameters at 229. At 231 the memory is scanned for errors which can be performed by the known scandisk routines. Scandisk can find different types of errors on hard disk and is able to correct some of them. Among other things, scandisk checks the disk platters for defects and also looks for lost clusters that are sometimes created when a program aborts. Errors requiring data recovery not rectified by scandisk are handled by the restart-recovery routine which operates on a forensic level. In addition, the memory is cleared at 233. This can include defragmenting the memory which removes any remnants of instructions or data that remain after processing and temporary files which are no longer needed such as, for example, global network temporary files and program temporary files, downloaded programs already loaded, and slack no longer needed. In addition, page spacing required for new instructions is readjusted. If desired, an integrity check can be performed at 235 by calling the purity routine. In addition, a test routine can be run at 237. The test routine runs a problem having a known answer. The results are analyzed at 239 by checking the known results to the processed results to verify that performance and calibration determinations are met. Thus, the test is used as a performance and reliability benchmark. If the answer is wrong, then a system failure has occurred, otherwise, the amount of time it takes to calculate the answer is compared with known values, which may be stored in the process map 27, to determine if the system is performing optimally.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A method of maintaining operation of a digital system performing in a predetermined order a set of instructions stored in a memory, the method comprising the steps of operating the digital system to:
perform each instruction in the set of instructions in the predetermined order;
place in memory the results of the performance of each instruction;
detect faults in the performance of the instructions; and
upon detection of a fault, automatically restart the performance of the set of instructions in the predetermined order.

2. The method of claim 1, wherein operation of the digital system to perform instructions includes under selected conditions operating the digital system to perform a calibration of the digital system.

3. The method of claim 2 wherein a selected condition for operating the digital system to perform a calibration comprises the elapse of a selected time interval.

4. The method of claim 2 wherein a selected condition for operating the digital system to perform a calibration comprises the processing of a selected number of instructions.

5. The method of claim 2 wherein the operation of the digital system to perform a calibration includes performance of a calibration upon detection of a fault and before the digital system is operated to automatically restart the performance of the set of instructions in the predetermined order.

6. The method of claim 2 wherein operation of the digital system to perform a calibration includes at least one of operating the digital system to clean up unused resources, reinitialize device elements, and clear interrupts.

7. The method of claim 6 wherein operation of the digital system to clean up unused resources comprises at least one of: operating the digital system to remove from memory instructions no longer needed, releasing resources utilized during processing of instructions, and defragmenting memory.

8. The method of claim 2 wherein operation of the digital system to perform a calibration comprises operating the digital system to execute a given set of instructions with a given set of initial conditions to generate results, and checking the generated results against known results and known run time, and logging the outcome to memory.

9. The method of claim 1 wherein the set of instructions is stored in a secured memory and operation of the digital system to perform the set of instructions comprises operating the digital system to copy the set of instructions from the secured memory to an open memory and then perform the set of instructions using the set of instructions in the open memory.

10. The method of claim 9 wherein the digital system is further operated to check the results of the performance of the instructions for pure results, and wherein operating the digital system to place the results in memory comprises operating the digital system to only place pure results in the secured memory.

11. The method of claim 10 wherein operating the digital system to perform each instruction includes modification of an instruction to produce a modified instruction and wherein the results include modified instructions which are checked for pure results before being placed in secured memory, and wherein operating the digital system to automatically restart comprises operating the digital system to copy the set of instructions including any pure modified instructions from secured memory for performance.

12. A computer product comprising a computer readable medium having thereon a computer program which when loaded causes a digital system to execute procedures to:
perform each instruction in the set of instructions in the predetermined order;
place in memory the results of the performance of each instruction;
detect faults in the performance of the instructions; and
upon detection of a fault, automatically restart the performance of the set of instructions in the predetermined order.

13. The computer product of claim 12 which causes the digital system in performing a set of instructions to under selected conditions perform a calibration of the digital system.

14. The computer product of claim 13 which causes the digital system in performing a calibration to perform a calibration upon detection of a fault and before the digital system is operated to automatically restart the performance of the set of instructions in the predetermined order.

15. The computer product of claim 13 which causes the digital system in performing a calibration to perform at least one of operating a digital system to clean up unused resources, reinitialize device elements, and clear interrupts.

16. The computer product of claim 12 which causes the digital system to store the set of instructions in a secured memory and in operating the digital system to perform the set of instructions to operate the digital system to copy the set of instructions from the secured memory to an open memory and then to perform the set of instructions using the set of instructions in the open memory.

17. The computer product of claim 16 which causes the digital system to check the results of the performance of the instructions for pure results and in operating the digital system to place the results in memory to operate the digital system to only place pure results in the secured memory.

18. The computer product of claim 17 which causes the digital system in performing each instructions to modify an instruction to produce a modified instruction and wherein the results include modified instructions which are checked for pure results before being placed in secured memory, and causes the digital system in automatically restarting the performance of the set of instructions to copy the set of instructions including any pure modified instructions from the secured memory for performance.

19. A digital system comprising:
a memory storing a set of instructions;
means performing each instruction in the set of instructions in a predetermined order;
means placing in memory the results of the performance of each instruction;
means detecting faults in the performance of the instructions; and
means automatically restarting the performance of the set of instructions in the predetermined order upon detection of a fault.

20. The digital system of claim 19 wherein the means performing the instructions comprises means operating the digital system to perform a calibration of the digital system under selected conditions.

21. The digital system of claim 20 wherein the means performing a calibration comprises means performing a calibration upon detection of a fault and before restart by the means automatically restarting the performance of the set of instructions.

22. The digital system of claim 20 wherein the means performing a calibration includes means operating the digital system to perform at least one of: cleaning up unused resources, reinitializing device elements, and clearing interrupts.

23. The digital system of claim 19 wherein the memory includes a secured memory and an open memory and the means performing the set of instructions comprises means copying a set of instructions from the secured memory to the open memory and then performing the set of instructions in the open memory.

24. The digital system of claim 23 wherein the digital system further includes means checking the results of the performance of the instructions for pure results and the means placing the results in memory comprises means only placing pure results in the secured memory.

25. The digital system of claim 24 wherein the means performing each instruction includes means modifying an instruction to produce a modified instruction and the means replacing pure results in the secured memory only places pure modified instructions in the secured memory and wherein the means automatically restarting the performance of the set of instructions includes means copying the set of instructions including any pure modified instructions from the secured memory for performance.

26. A method of operating a digital system which manipulates file units stored in a memory area and comprising any one of data, program instructions, and combinations and portions of data and program instructions, the method comprising the steps of operating the digital system to:
repeatedly withdraw file units from the memory area;
process each file unit withdrawn from the memory area to generate a new generation of the file unit;
associate each generation of each file unit with the file unit from which it was generated; and
maintain in memory at least the two most recent generations of each file unit.

27. The method of claim 26 wherein generating a file unit comprises operating the digital system to generate the new file unit containing all of the contents of the file unit from which the new generation of the file unit was generated plus changes to the file unit produced by the processing.

28. The method of claim 26 wherein associating each generation of each file unit with the file unit from which it was generated comprises operating the digital system to generate a memory map linking the generations of each file unit.

29. The method of claim 28 wherein maintaining in memory comprises operating the digital system to maintain each generation of a file unit in memory.

30. The method of claim 29 wherein the process of generating a new generation of a file unit comprises operating the digital system to generate a file unit identifying changes from the file unit from which the new file unit was generated.

31. The method of claim 26 wherein associating each generation of a file unit comprises operating the digital system to establish purity of a latest generation of each file unit after processing before placing this latest generation of the file unit in the memory area.

32. The method of claim 31 wherein establishing purity further includes operating the digital system to attempt to make pure the latest generation of a file unit that is not pure.

33. The method of claim 31 wherein processing includes operating the digital system to use the most recent file unit that is pure when a generation of a file unit is found to be impure.

34. The method of claim 28 wherein the memory includes a secured memory and an open memory, and maintaining file units in memory comprises operating the digital system to maintain the generations of each file unit in the secured memory and withdrawing a file unit from the memory comprises operating the digital system to copy the selected generation of a file unit from the secured memory into the open memory, and wherein processing comprises operating the digital system to use the copy of the selected generation of the file unit in the open memory.

35. The method of claim 34 including operating the digital system to establish the purity of each generation of a file unit before storing it in the secured memory.

36. A computer product comprising a computer readable medium having thereon a computer program which when loaded causes a digital system to execute procedure to:
repeatedly withdraw file units from the memory area;
process each file unit withdrawn from the memory area to generate a new generation of the file unit;
associate each generation of each file unit with the file unit from which it was generated; and
maintain in memory at least the two most recent generations of each file unit.

37. The computer product of claim 36 which causes the digital system in associating each generation of each file unit with a file unit from which it was generated to operate the digital system to generate a memory map linking the generations of each file unit.

38. The computer product of claim 36 which causes the digital system in associating each generation of a file unit to operate the digital system to establish purity of a latest generation of each file unit after processing before placing this latest generation of the file unit in the memory area.

39. The computer product of claim 38 which causes the digital system in establishing purity to further operate the digital system to attempt to make pure the latest generation of a file unit that is not pure.

40. The computer product of claim 38 which causes the digital system in processing each file unit to operate the digital system to use the most recent file unit that is pure when a generation of a file unit is found to be impure.

41. The computer product of claim 37 which causes the digital system in maintaining file units in memory to operate the digital system to maintain the generations of each file unit in a secured memory and in withdrawing a generation of a file unit from the secured memory to operate the digital system to copy of the selected generation of a file unit from the secured memory into an open memory, and wherein in processing each file unit to operate the digital system to use the copy of the selected generation of the file unit in the open memory.

42. A digital system comprising:
a memory storing file units comprising data, program instructions and combinations and portions thereof; and
digital processor means comprising:
means repeatedly withdrawing file units from the memory area;
means processing each file unit withdrawn from the memory area to generate a new generation of the file unit;
means associating each generation of each file unit with the file unit from which it was generated; and
means maintaining in memory at least two most recent generations of each file unit.

43. The digital system of claim 42 wherein the means associating each generation of each file unit with the file unit from which it was generated comprises means operating the digital system to generate a memory map linking the generations of each file unit.

44. The digital system of claim 42 wherein the means associating each generation of a file unit comprises means operating the digital system to establish purity of a latest generation of each file unit after processing before placing this latest generation of the file unit in the memory area.

45. The digital system of claim 44 wherein the means operating the digital system to establish purity further includes means operating the digital system to attempt to make pure the latest generation of a file unit that is not pure.

46. The digital system of claim 44 wherein the processing means includes means operating the digital system to use the most recent file unit that is pure when a generation of a file unit is found to be impure.

47. The digital system of claim 43 wherein the memory includes a secured memory and an open memory and wherein the means maintaining file units in memory comprises means operating the digital system to maintain the generations of each file unit in the secured memory and the means withdrawing a file unit from memory comprises means operating a digital system to copy the selected generation of file units from the secured memory into the open memory, and wherein the means processing each file unit comprises means operating a digital system to use the copy of the selected generation of the file unit in the open memory.

48. A method of operating a digital system which manipulates file units comprising data, program instructions, and combinations and portions of data and program instructions, the method comprising the steps of operating the digital system to:
withdraw file units from a memory area;
process the file units to generate processed file units;
establish purity of the processed file units; and
place pure processed file units in the memory area.

49. The method of claim 48 wherein withdrawing file units from the memory area further comprises operating the digital system to verify purity of at least some file units prior to the step of processing.

50. The method of claim 49 wherein verifying purity of at least some of the file units includes operating the digital system to perform a bit-by-bit analysis on a file unit which is not verified as pure.

51. The method of claim 50 wherein performing a bit-by-bit analysis includes isolating a file unit as compromised when the bit-by-bit analysis detects at least one of: an inappropriate instruction, more than one header, more than one end of file marker, a mismatch between the header and end of file marker, and at least one unreadable or missing bit.

52. The method of claim 50 wherein performing the bit-by-bit analysis comprises operating the digital system to convert a data element of the file unit to hex code and comparing the data element hex code to of library of hex codes to identify missing, unreadable or additional bits in the data element.

53. The method of claim 50 adapted for use with a file unit having an imbedded check code wherein performing the bit-by-bit analysis comprises operating the digital system to identify a missing or unreadable bit, generate a calculated check code from readable bits, compare the calculated check code to the imbedded check code and substitute a bit for the missing or unreadable bit which makes the calculated check code equal the imbedded check code.

54. The method of claim 51 including operating the digital system to perform a recovery on a comprised file unit.

55. The method of claim 48 wherein each file unit is tagged with an identifying tag containing predetermined identifying elements and establishing purity comprises operating the digital system to establish that the file unit has a tag with the predetermined identifying elements.

56. The method of claim 55 wherein placing file units in the memory area includes operating the digital system to store the identifying tag for the file unit being stored in a memory map and establishing purity comprises operating the digital system to compare the contents of the identifying tag on a file unit with the elements of the identifying tag of that file unit stored in the memory map.

57. The method of claim 56 wherein an identifying element contained in the identifying tag is a check code.

58. The method of claim 56 wherein an identifying element of the identifying tag of each file unit is a unique identifier identifying that file unit.

59. The method of claim 56 wherein processing includes operating the digital system to perform a bit-by-bit analysis of a file unit when the identifying elements of the file unit do not agree with the identifying elements stored in the memory map.

60. The method of claim 59 wherein a file unit is tagged as compromised when the bit-by-bit analysis detects at least one of: an inappropriate instruction, more than one header, more than one end of file marker, a mismatch between header and end of file marker, and at least one unreadable or missing bit.

61. The method of claim 60 including operating the digital system to perform a recovery on a comprised file unit.

62. The method of claim 56 adapted for use with a plurality of associated digital systems and wherein tagging comprises assigning to each digital system a unique digital system ID, processing by each digital system includes operating the digital system to add the unique digital system ID to the tag of each file unit processed, and establishing purity includes operating the digital system to check the digital system ID contained in the tag of each file unit for one of the assigned unique digital system IDs.

63. The method of claim 62 wherein storing a tag element in the memory map includes operating the digital system to log in the memory map the current digital system ID and at least the next most recent digital system ID when that file unit came from another of the associated digital systems.

64. The method of claim 48 wherein establishing purity comprises performing a bit-by-bit analysis on a file unit.

65. The method of claim 48 wherein performing a bit-by-bit analysis on a file unit includes isolating a file unit as compromised when the bit-by-bit analysis detects at least one of: an inappropriate instruction, more than one header, more than one end of file marker, a mismatch between the header and end of file marker, and at least one missing or unreadable bit.

66. A computer product comprising a computer readable medium having thereon a computer program which when loaded causes a digital system to execute procedure to:
withdraw file units from a memory area;
process the file units to generate processed file units;
establish purity of the processed file units; and
place pure processed file units in the memory area.

67. The computer product of claim 66 which causes the digital system in withdrawing file units from the memory area to verify purity of each file unit prior to processing the file units to generate processed file units.

68. A digital system comprising:
a memory storing file units comprising data, program instructions and combinations and portions thereof; and
digital processor means comprising:
means withdrawing file units from the memory;
means processing the file units to generate processed file units;
means establishing purity of the processed file units; and
means placing pure processed file units in the memory.

69. A method of operation, self test and recovery of a digital system comprising automatically operating the digital system to:
detect corrupted file units; and
replace the corrupted file units with uncorrupted file units.

70. The method of claim 69 wherein operating the digital system to replace a corrupted file unit comprises substituting an uncorrupted version of the corrupted file unit stored in a memory for the corrupted file unit.

71. The method of claim 70 wherein operating the digital system to detect corrupted file units comprises operating the digital system to perform a bit-by-bit analysis of a file unit, and identifying a file unit with at least one unreadable, missing or additional bit as a corrupted file unit.

72. The method of claim 69 wherein operating the digital system to replace the corrupted file unit comprises reconstructing the corrupted file unit.

73. The method of claim 72 wherein operating the digital system to replace the corrupted file unit comprises substituting an uncorrupted version of the corrupted file unit stored in a memory for the corrupted file unit when the corrupted file unit cannot be reconstructed.

74. The method of claim 72 wherein operating the digital system to detect corrupted file units comprises operating the digital system to perform a bit-by-bit analysis of a file unit, and identifying a file unit with at least one unreadable, missing or additional bit as a corrupted file unit.

75. The method of claim 74 wherein operating the digital system to reconstruct the corrupted file unit comprises operating the digital system to substitute bits for the unreadable or missing bits.

76. The system of claim 75 wherein operating the digital system to substitute bits comprises operating the digital system to compare the corrupted file unit bit-by-bit with an uncorrupted version of the corrupted file unit stored in a memory, and to substitute corresponding bits in the uncorrupted version of the corrupted file unit for unreadable or missing bits in the corrupted file unit.

77. The method of claim 75 wherein operating the digital system to substitute bits comprises operating the digital system to compare readable bits of the corrupted file unit with a character code set to determine a best match character code and to substitute the best match character code in the corrupted file unit containing the unreadable or missing bits.

78. The method of claim 77 wherein operating the digital system to determine the best match character code comprises operating the digital system to determine a plurality of potential best character code matches, and to perform at least one of a spell check, a dictionary check, and a grammar check on the potential best character code matches to determine the best character code match.

79. The method of claim 78 wherein each file unit contains a check code and determining the best character code match includes selecting the potential best character code match that produces the check code.

80. The method of claim 77 wherein operating the digital system to reconstruct a corrupted file unit comprises substituting an uncorrupted version of the corrupted file unit stored in a memory for the corrupted file unit when a best match character code cannot be found.

81. The method of claim 74 wherein each file unit includes a check code and operating the digital system to substitute bits comprises substituting for unreadable or missing bits, bits that produce the check code.

82. The method of claim 81 wherein the file units are expressed in hex code and substituting for unreadable or missing bits comprises substituting a hex code which produces the check code.

83. The method of 81 wherein substituting bits comprises operating the digital system to recover from a memory map the check code of a corrupted file unit having at least one unreadable or missing bit in the check code.

84. The method of claim 69 wherein operating the digital system to detect a corrupted file unit comprises operating the digital system to perform a bit-by-bit check of a file unit, and identifying a file unit as corrupted which has at least one of: an inappropriate instruction, more than one header, more than one end of file marker, a mismatch between the header and end of file marker, and at least one unreadable or missing bit.

85. A computer product comprising a computer readable medium having thereon a computer program which when loaded causes a digital system to execute procedure to:
detect corrupted file units; and
replace the corrupted file units with uncorrupted file units.

86. A digital system comprising a digital system processor having means to detect corrupted file units, and means to replace the corrupted file units with uncorrupted file units.

87. A method of changing instructions in a digital system comprising the steps of operating the digital system to:
make exact copies of existing instructions to be changed and exact copies of data affected by the existing instructions to be changed;
apply proposed changes to the exact copies of existing instructions to generate proposed instructions;
execute the proposed instructions using the exact copies of data affected;
analyze results for compromise to any one or more of: proposed instructions, exact copies of data, and system operation; and
select from among the proposed instructions certain ones for use as changed instructions based on the analysis of the results.

88. The method of claim 87 wherein applying changes further includes adding additional instructions as proposed instructions.

89. The method of claim 87 wherein analyzing the results includes checking the purity of the proposed instructions.

90. The method of claim 89 wherein the existing instructions and data affected by existing instructions are stored in a secured memory, the exact copies of the existing instructions and data affected by existing instructions are copied to an open memory and wherein the changed instructions which are pure are stored in the secured memory.

91. The method of claim 89 wherein the existing instructions and proposed instructions have a predetermined structure and the check for purity includes checking that the proposed instructions have the predetermined structure in order to be pure.

92. The method of claim 87 wherein each existing instruction and each change to an existing instruction has a predetermined structure which is verified before the changes are applied to the existing instructions to generate the proposed instruction.

93. The method of claim 92 adapted for use with a plurality of digital systems wherein each digital system processing an existing instruction or proposed instruction inserts in the predetermined structure a unique digital system identifier and wherein verifying the predetermined structure includes confirming the presence of the digital system identifier of one of the associated digital systems.

94. A computer product comprising a computer readable medium having thereon a computer program which when loaded causes a digital system to execute procedure to:
make exact copies of existing instructions to be changed and exact copies of data affected by the existing instructions to be changed;
apply proposed changes to the exact copies of existing instructions to generate proposed instructions;
execute the proposed instructions using the exact copies of data affected;
analyze results for compromise to any one or more of:
proposed instructions, exact copies of data, and system operation; and
select from among the proposed instructions certain ones for use as changed instructions based on the analysis of the results.

95. A digital system comprising:
means making exact copies of existing instructions to be changed and exact copies of data affected by the existing instructions to be changed;
means applying proposed changes to the exact copies of existing instructions to generate proposed instructions;
means executing the proposed instructions using the exact copies of data affected;
means analyzing results for compromise to any one or more of: proposed instructions, exact copies of data, and system operation; and
means selecting from among the proposed instructions certain ones for use as changed instructions based on the analysis of the results.

96. A method of operating a plurality of digital systems which are connected for communication with one another, and at least two of which are associated digital systems and at least one of which is an unassociated digital system, the method comprising:
providing each of the associated digital systems with a digital identifier unique to that associated digital system; and
operating the associated digital systems to:
each insert in a tag in all file units processed, the unique digital identifier assigned to that digital system; and
only process file units with a tag containing one of the assigned unique digital identifiers.

97. The method of claim 96 wherein the unique digital identifier is provided to the digital systems in firmware.

98. The method of claim 96 wherein inserting the assigned unique digital identifier comprises operating each associated digital system to encrypt the assigned unique digital identifier inserted in the tag and processing file units comprises operating each associated digital system to first decrypt the tag of each file unit to determine the presence of one of the assigned unique digital identifiers.

99. The method of claim 98 wherein each associated digital system is operated to encrypt the assigned unique digital identifier inserted in the tags and to decrypt the tags in a first processor, and to process the file units in a second processor.

100. The method of claim 98 wherein each of the digital systems is operated to encrypt the tag of each file unit using a first encryption key and to encrypt data elements of the file units with a second encryption key which is included in the tag and encrypted with the first encryption key, and wherein processing file units includes operating each associated digital system to decrypt the second encryption key in the tag of each file unit using the first encryption key and then using the second encryption key to decrypt the data elements.

101. A computer product comprising a computer readable medium having thereon a computer program which when loaded into each of a plurality of digital systems causes each of the digital systems to execute procedure to insert in a tag in all file units processed by the digital system a unique digital identifier assigned to that digital system and to only process file units with a tag containing one of the assigned unique digital identifiers.

102. A plurality of digital systems each having:
a processor;
means inserting in a tag in all file units processed by the processor a unique digital identifier assigned to that digital system; and
means allowing processing by the processor only if file units with a tag containing one of the assigned unique digital identifiers assigned to the plurality of digital systems.

103. A method of operating a first digital system connected for communication with at least one other digital system, the method comprising operating the first digital system to:
perform processing of file units;
at least partially encrypt each file unit after each performance of processing; and
only decrypt the at least partially encrypted file units to form decrypted file units for the performance of processing.

104. The method of claim 103 wherein the file units are encrypted and decrypted in a first processor and file units are processed in a second processor.

105. The method of claim 103 wherein the first digital system is operated to fully encrypt the file units by encrypting tags of the file units using a first encryption key and to encrypt data elements of the file units with a second encryption key which is included in the tags and encrypted with the first encryption key, and the first digital system is further operated to decrypt the second encryption key in the tags of the file units using the first encryption key and then using the second encryption key to decrypt the data elements.

106. A computer product comprising a computer readable medium having thereon a computer program which when loaded causes a digital system to execute procedures to:
perform processing of file units;
at least partially encrypt each file unit after each performance of processing; and
only decrypt the at least partially encrypted file units to form decrypted file units for the performance of processing.

107. A digital system comprising:
means processing file units;
means at least partially encrypting each file unit after performance of processing by the processing means; and
means only decrypting the at least partially encrypted file units to form decrypted file units for processing by the processing means.

108. A method of operating a digital system comprising automatically operating to:
purify file units containing program instructions to generate pure file units;
store the pure file units in a secured memory;
copy the pure file units to an open memory;
execute a sequence of program instructions in the file units copied to open memory;
detect faults occurring during execution of the sequence of program instructions in the file units copied to open memory;
restart the sequence of program instructions in file units copied to open memory;
when restart is not effected, make a new copy in open memory of the pure file units in secured memory; and
execute the sequence of program instructions in the file units newly copied to open memory.

109. A computer product comprising a computer readable medium having thereon a computer program which when loaded causes a digital system to execute procedures to:
purify file units containing program instructions to generate pure file units;
store the pure file units in a secured memory;
copy the pure file units to an open memory;
execute a sequence of program instructions in the file units copied to open memory;
detect faults occurring during execution of the sequence of program instructions in the file units copied to open memory;
restart the sequence of program instructions in file units copied to open memory;
when restart is not effected, make a new copy in open memory of the pure file units in secured memory; and
execute the sequence of program instructions in the file units newly copied to open memory.

110. A digital system comprising:
a secured memory;
an open memory;
means purifying file units containing program instructions to generate pure file units;
means storing the pure file units in the secured memory;
means copying the pure file units from the secured memory to the open memory;
means executing a sequence of program instructions in the file units copied to open memory;
means detecting faults occurring during execution of the sequence of the program instructions in the file units copied to open memory;
means restoring the sequence of program instructions in the file units copied to open memory;
means making a new copy in open memory of pure file units in secured memory when restart is not effected;
means executing the sequence of program instructions in the file units newly copied to open memory.

111. A method of operating a digital system which manipulates file units including file units containing sets of program instructions, the method comprising operating the digital system to:
maintain a process map listing characteristics of the sets of program instructions in file units containing sets of program instructions;
processing the sets of instructions in the file units containing sets of instructions; and
map to the process map effects on the characteristics resulting from processing.

112. The process of claim 111 wherein processing includes changing instructions by generating proposed instructions, preprocessing the proposed instructions, detecting any comprises caused by the proposed instructions, and mapping the compromises to the process map.

113. The method of claim 112 wherein processing further includes selecting as new instructions proposed instruction not identified in the process map as producing a comprise.

114. The method of claim 111 wherein a characteristic maintained by the process map is an indication of a need for a calibration of the digital system, and processing includes performing a calibration when the process map indicates a need for a calibration.

115. The method of claim 111 wherein a characteristic maintained in the process map includes a run time for a given set of instructions and processing includes comparing an actual run time for the given set of instructions with the run time in the process map.

116. A computer product comprising a computer readable medium having thereon a computer program which when loaded causes a digital system to execute procedure to:
maintain a process map listing characteristics of the sets of program instructions in file units containing sets of program instructions;
processing the sets of instructions in the file units containing sets of instructions; and
map to the process map effects on the characteristics resulting from processing.

117. A digital system comprising:
a memory storing file units including file units containing sets of program instructions;
means maintaining a process map listing characteristics of the sets of instructions in file units containing sets of instructions;
means processing the sets of instructions in the file units stored in the memory; and
means mapping to the process map effects on the characteristics of the sets of instructions resulting from processing.
